(19) United States
(12) Patent Application Publication
(10) Pub. No.: US 2008/0272241 A1
(43) Pub. Date: Nov. 6, 2008

(54) Device for Reducing a Drag Produced by the Relative Displacement of a Body and Fluid

(75) Inventor: Yvan Brulhart, Carouge (CH)

Correspondence Address: YOUNG & THOMPSON, 209 Madison Street, Suite 500, ALEXANDRIA, VA, 22314, US

(73) Assignees: DRS Drag Reduction Systens SA, Port Louis (MU); Magising PTE LTD., Singapore (SG)

(21) Appl. No.: 12/095,929

(22) PCT Filed: Dec. 5, 2006
(86) PCT No.: PCT/IB06/03474

§ 371 Date: Jun. 3, 2008

(30) Foreign Application Priority Data
Dec. 6, 2005 (CH) 01928/05

(51) Int. Cl. B64C 21/10; B62D 37/02; F15D 1/06

(52) U.S. Cl. 244/200.1; 296/180.1; 138/39

(57) ABSTRACT

The device reduces the drag or head loss due to the relative motions of a body and a fluid or of a fluid in a body. Within the surface of the body in contact with the fluid or on top of this surface, the device has elements (2) serving to control the direction of rotation of the fluid eddies along the surface of the body, thus reducing the frictional forces between the fluid and the body, and hence the drag, the constraints to which the body is subjected, or the head loss of the fluid.

When a body is moved inside of a fluid, or when a fluid flows around or within a body, this body is subject to a pressure arising from the speed of the fluid passing around the body or from its being confined within the body, and to a force acting in the direction opposite to that of the movement of the body or in the direction of fluid flow. This force that opposes the movement of the body within the fluid or that of the fluid within the body is the frictional drag or friction head loss. In laminar flow, the drag is relatively weak, but as soon as the relative velocities of the body and fluid increase, the flow becomes turbulent at least around certain portions of the surface of the body immersed into the fluid. This turbulent flow gives rise to fluid eddies around or along the body that have a direction of rotation such that the layer of fluid in contact with or in the vicinity of the body has a component of movement directed in the direction opposite to that of the body or in the direction of fluid flow. This strongly enhances the drag, and notably the frictional drag or friction head loss, in such a way that a thrust much larger must be applied to a moving body in order to secure its movement, or the pumping force must be raised in order to maintain the fluid flow rate in a channel. In addition, this raises the constraints to which the body is subjected.

This phenomenon is found in particular for any movement of vehicles such as ships in water or cars, trains, and planes in the air, with the consequence of an additional expenditure of energy or fuel for the higher thrust needed to combat the drag. In the case of immobile bodies, it is necessary to design them so that they will resist these forces and constraints. In the case of a fluid circulating in pipes, finally, this may lead to phenomena of cavitation and requires higher pumping power in order to secure the fluid flow rate.

It is the aim of the present invention to realize means with which one may create, and control the direction of rotation of, eddies due to turbulent flow of a fluid around or within a body in such a way that the frictional forces between at least part of the body's surface and the fluid will be reduced, and in this way reduce the drag, the constraints, and the head loss.

In fixed structures, buildings, bridges, wind turbines and the like, the device according to the invention is able to lower the constraints due to the flow of fluids to which they are subjected, and thus to reduce their fatigue and wear.

The device according to the invention that reduces the drag arising from the motion of a body in a fluid, the constraints to which a fixed body is subjected, or the head losses arising from fluid flow in a channel, obviates the drawbacks just cited, and allows the aim set forth above to be attained, and is distinguished by the characteristics listed in claim 1.

The annexed drawing illustrates, on the one hand the phenomenon of turbulent flow around a body in the way in which it arises naturally, and on the other hand in the way in which it appears around or within a body fitted with a device according to the invention.

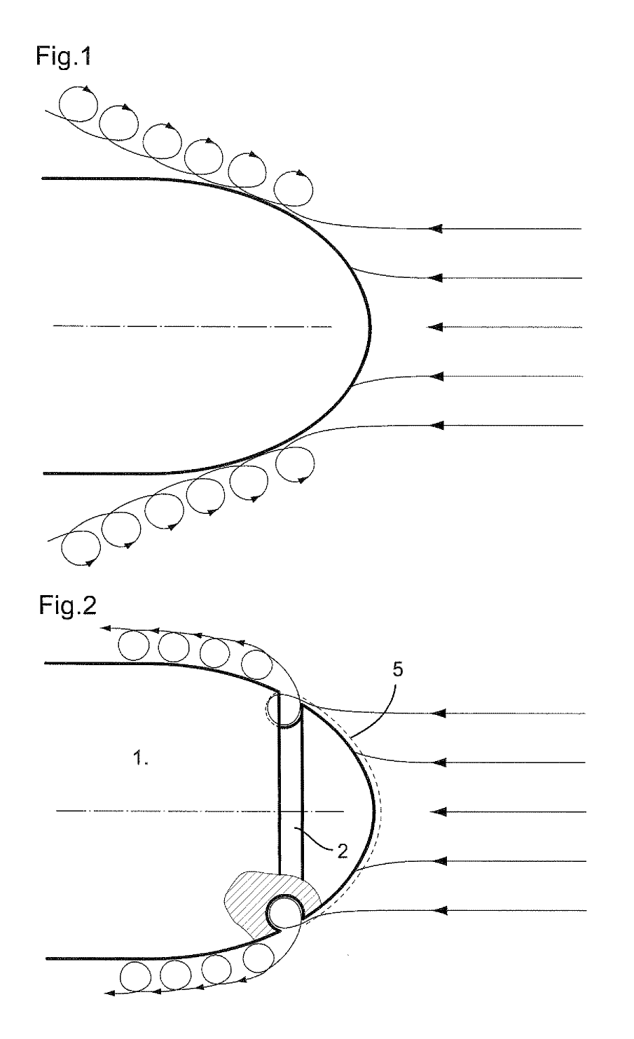

FIG. 1 schematically illustrates the turbulent flow around a body moved within a fluid, or of a fluid moving around a body.

FIG. 2 schematically illustrates a body fitted with a device according to the invention, and the modified flow resulting from it.

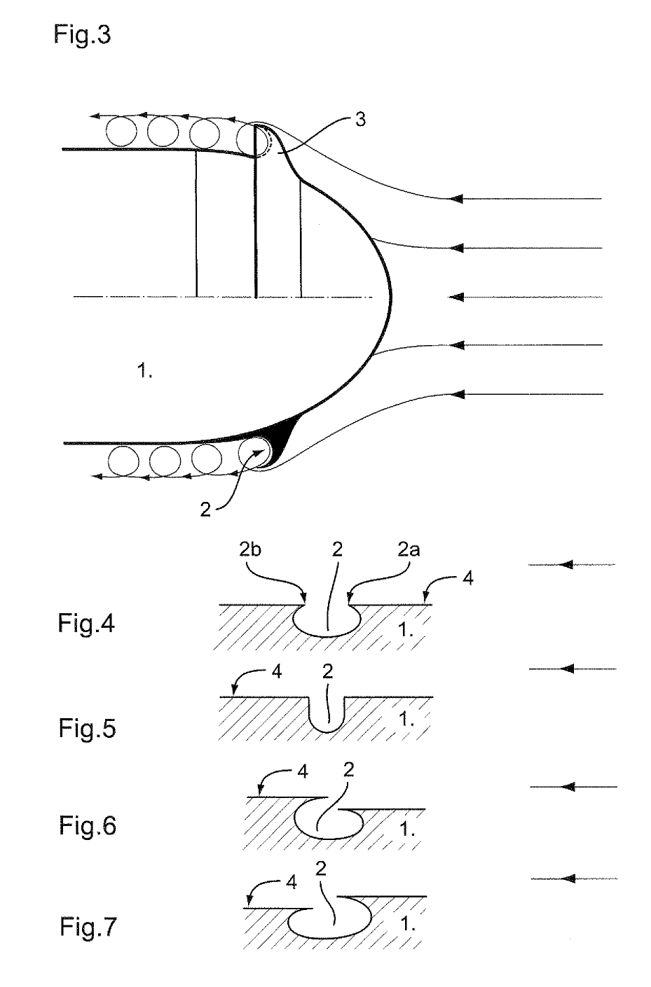

FIG. 3 illustrates a body fitted with a variant of the means according to the invention.

FIGS. 4 to 7 illustrate by way of examples that are not exhaustive, different forms that may be assumed by the means according to the invention.

FIG. 8 illustrates a smooth, self-adhesive profile fitted with means according to the invention.

FIG. 9 illustrates a train fitted with a device according to the invention.

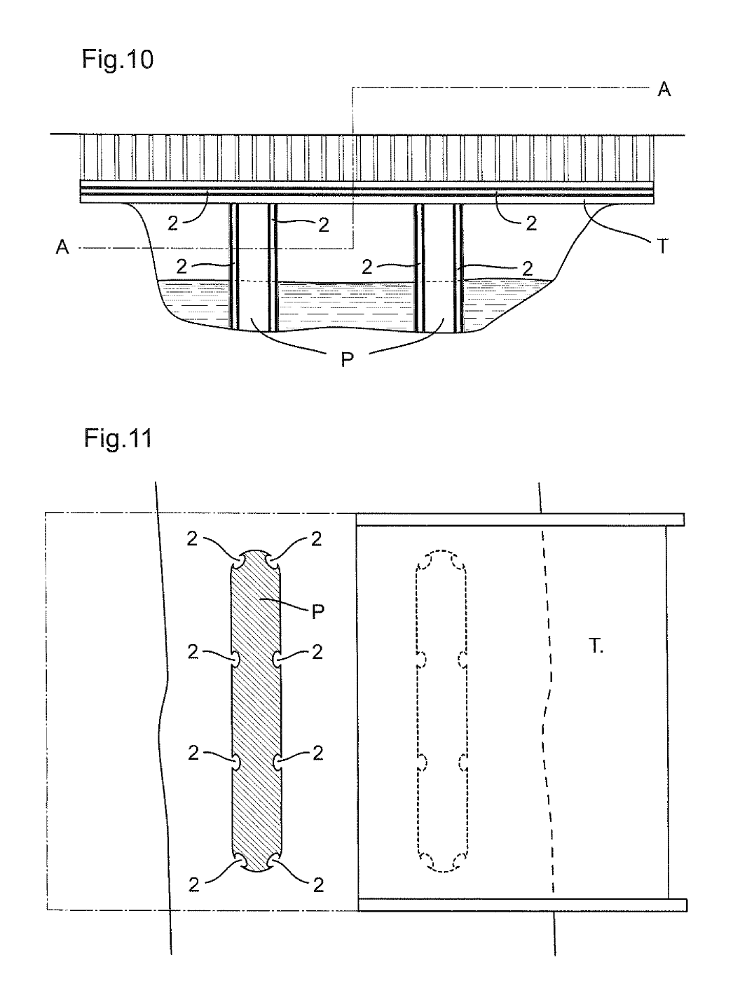

FIGS. 10 and 11 illustrate a bridge as seen from the side and, partly sectioned along the line A-A, from above that is fitted with the device according to the invention.

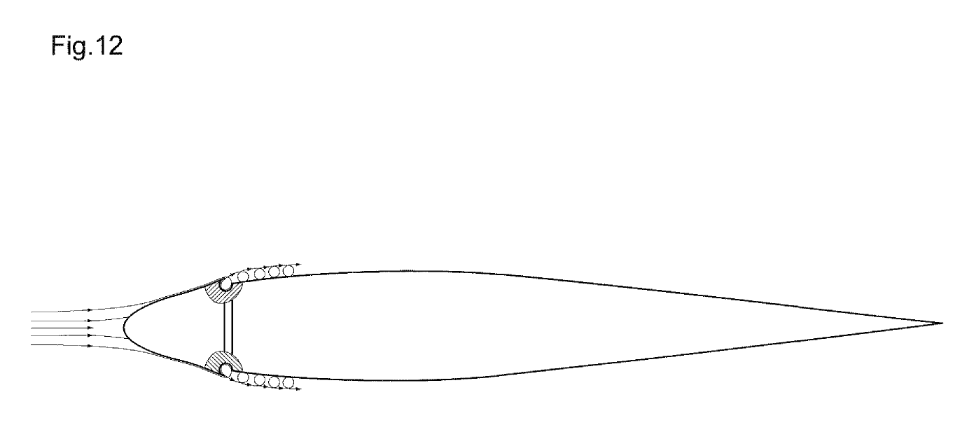

FIG. 12 is a scheme of a nose cone fitted with a device for drag reduction and used for tests performed.

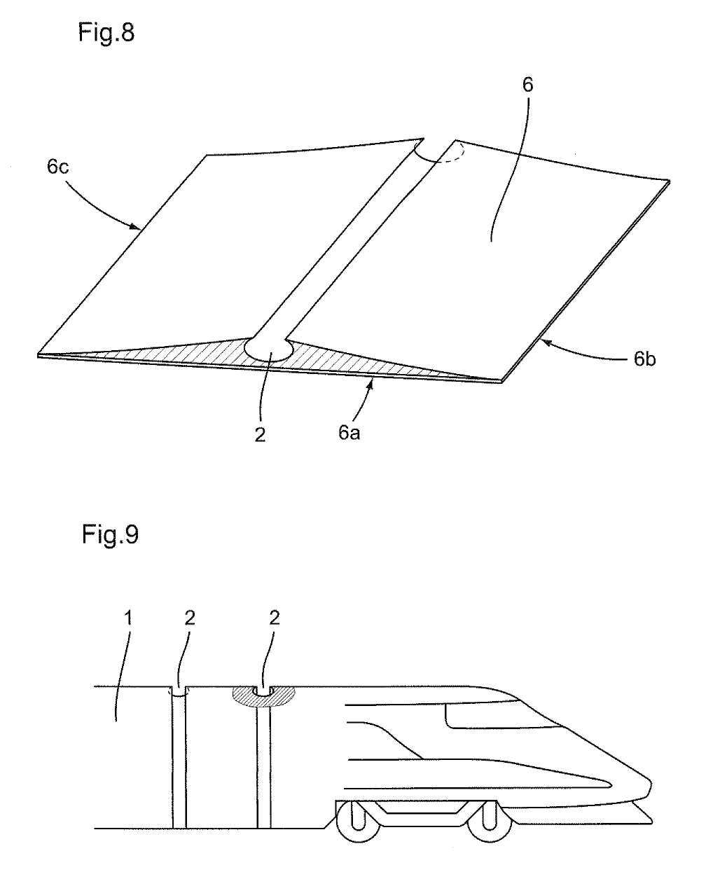

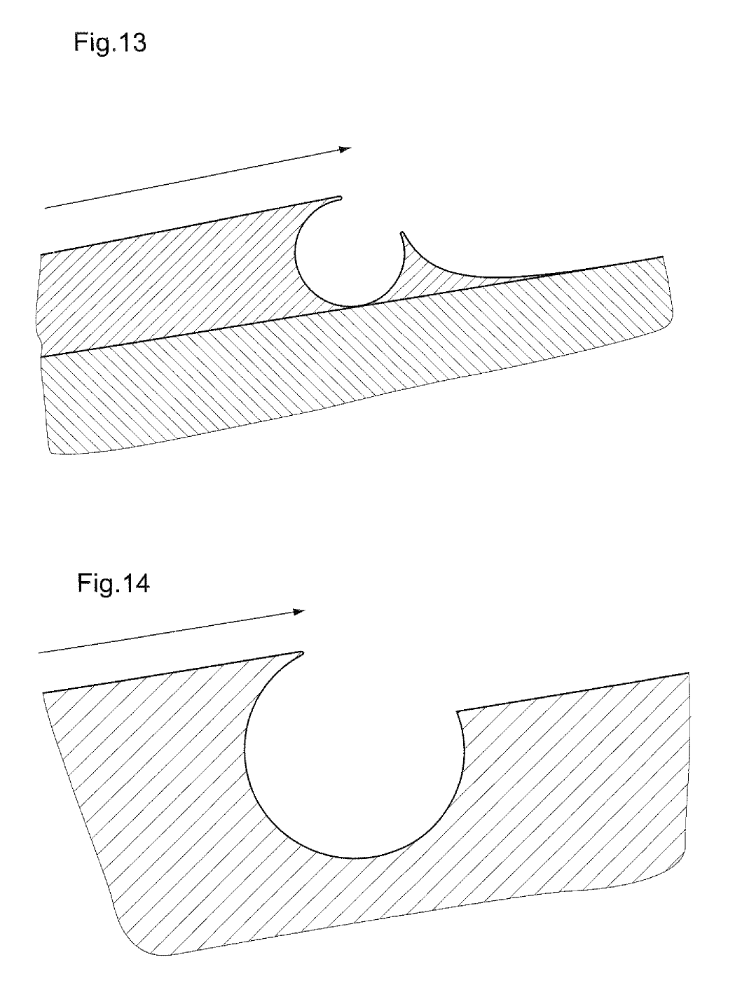

FIG. 13 illustrates part of a nose cone to which a device according to FIG. 7 has been applied, and that has served as a basis for efficiency tests.

FIG. 14 illustrates part of a nose cone that was fitted with a device according to FIG. 7 inlaid into the nose cone, and that has served as a basis for efficiency tests.

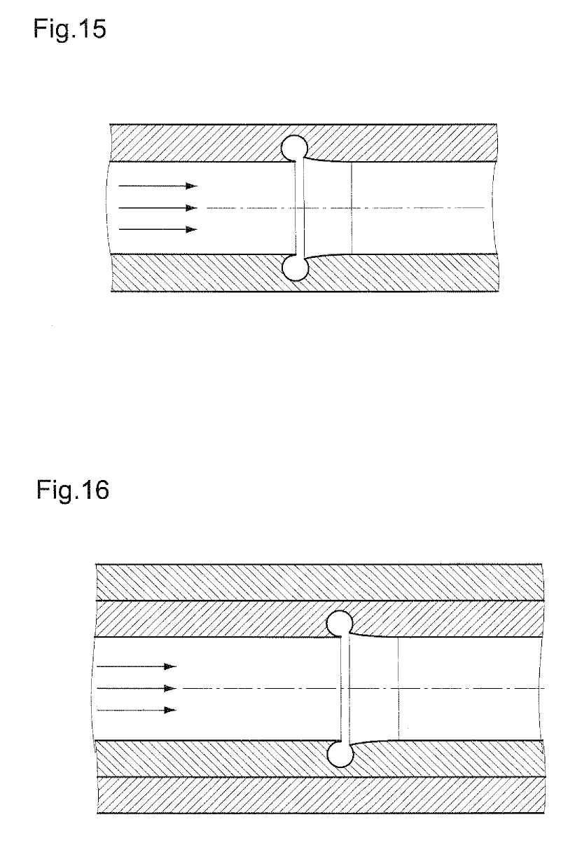

FIG. 15 illustrates piping fitted with the inlaid device.

FIG. 16 illustrates piping fitted with the attached device.

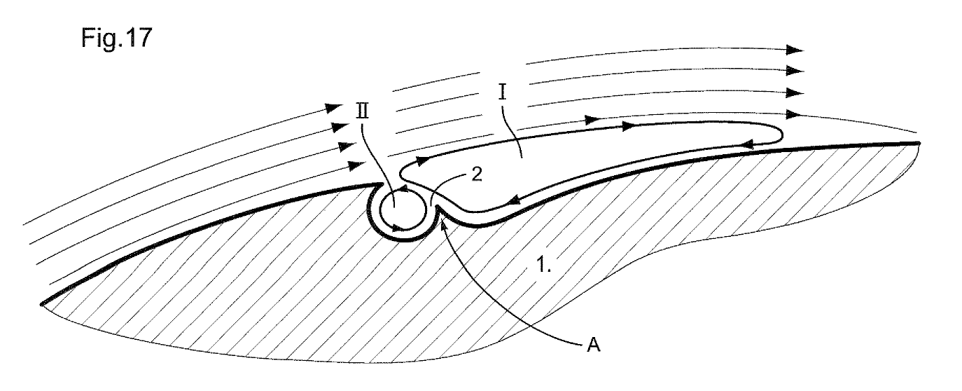

FIG. 17 illustrates the recirculating phenomenon obtained by the device.

FIG. 1 schematically shows that, when a body moves within a fluid or a fluid flows around this body, conditions of turbulent flow come about as the relative velocities of the body and fluid increase, and give rise to fluid eddies having a large velocity and a direction of rotation such that the fluid threads in contact with the surface of the body have a velocity relative to the body that is larger than the velocity of movement of the body through the fluid, but is in the opposite direction. This raises the friction forces between the fluid and the body, and hence the drag, particularly the frictional drag.

These eddies in addition move away from the body, which raises the instability of flow along the surface of said body and causes a separation, and thus a more important drag.

FIG. 2 illustrates a body 1 fitted with means 2 allowing one to control and channel more particularly the direction of rotation of the eddies of turbulent flow around the body.

In the example illustrated, these means 2 are formed by a groove that extends over the entire surface of body 1 that is immersed into the fluid, and that preferably extends essentially perpendicularly to the fluid flow. This groove 2 has a form such that the fluid threads in contact with at least part of the surface of body 1 that arrive at this groove penetrate into it, and leads to a direction of rotation that is such that the fluid threads in contact with the body downstream from the device have a velocity relative to body 1 that is in the direction of movement of this body, that is, opposite to that of fluid flow, the direction of rotation of the eddies having been controlled and channeled by means 2. The frictional forces between the fluid and body 1 thus are reduced, and the drag diminished. The device according to the invention that includes groove 2 made it possible to invert the direction of rotation of the eddies, and thus to reduce the frictional drag at least over some distance downstream from groove 2.

In addition, the direction of these eddies tends to reattach the fluid flow to the surface of the body, thus delaying the instant of separation and diminishing the drag.

The position of groove 2 relative to body 1 may vary, particularly as a function of shape of body 1, but this groove 2 is preferably located on the body at a place upstream from that where normally the turbulence of the boundary layer is created. Several grooves 2 may be arranged one behind the other along the body in different places on the body.

In the case of a train, car, or plane, this groove 2 may be closed upon itself, since the body is totally immersed into the air. In the case of a ship, to the contrary, groove 2 should only be provided on the part of the hull that is immersed.

In the case of a ship fitted with an immersed bulb, a groove 2 may again be arranged in this bulb over its entire periphery.

In the variant illustrated in FIG. 3, body 1 is fitted with a bulge 3 comprising groove 2. This bulge may be integral with the body, or consist of a profile fixed at body 1.

It can be seen in FIG. 2 that a region 5 on the front portion of bulb 1 is covered with a quasi stationary fluid calotte.

Seen in cross section, the shape of groove 2 may vary according to the embodiments, as illustrated schematically by way of example in FIGS. 4 to 7.

The variant illustrated in FIG. 4 includes a groove essentially symmetric, and having free edges 2a, 2b located in the extension of surface 4 of the body moving in the fluid. In this variant the groove extends over more than 180°, its free edges 2a, 2b being separated from each other by a distance smaller than the maximum width of groove 2.

In the variant illustrated in FIG. 5, groove 2 is generally U-shaped.

In the variants illustrated in FIGS. 6 and 7, groove 2 is asymmetric in the sense that one of its free edges 2a, 2b is offset relative to the outer envelope of the body plunged into the fluid, which in some cases facilitates fluid flow in this groove.

In the variants of FIGS. 4, 6, and 7, groove 2 is generally C-shaped.

FIG. 8 illustrates a profile 6 including a lower face 6a that can be fitted with a self-adhesive layer protected by a detachable foil. This profile has thin, tapering edges 6b, 6c and a thick central portion in which groove 2 is formed. This embodiment of the drag reduction device is practical and easy to implement, since it does not require modifying the shape of the body surface in contact with a fluid. It will suffice, in fact, to cut a length of profile 6 corresponding to the periphery of the body or body portion that should be fitted with the drag reduction device, and then glue this profile segment onto the body surface along the path desired, generally normal to the fluid flow, in order to fit the body with said drag reduction device formed by groove 2.

The device described allows one to control, straighten, and even out the fluid flow, which assumes a more stable velocity and pressure.

The result obtained with the aid of the device according to the invention is an important reduction of the drag to which a body moving in a fluid is subjected. Such a result is very important for all vehicles moving within a fluid: ships, trains, cars, planes, etc., since a reduction of drag and notably of frictional drag automatically produces a decrease in the energy needed for propulsion, hence a reduction of fuel consumption or an increase in speed of the vehicle.

As illustrated in FIG. 2, the device that is present on a body moving in a fluid may lead to formation of a stable fluid film 5 in the shape of a calotte on the front of body 1, again reducing the drag.

FIG. 9 illustrates a terrestrial vehicle fitted with two devices 2 according to the invention, one behind the other and separated by a certain distance. The distance between two devices along the vehicle preferably is smaller than the distance where the boundary layer develops downstream from the first device.

For fixed structures, buildings, wind turbines, off-shore platforms, bridges, and structures of any kind, the device according to the invention yields a reduction of the constraints to which they are subjected, and hence of their fatigue and/or wear.

As an example, a bridge seen from the side and from above and fitted with the device according to the invention has been represented in FIGS. 10 and 11.

The pylons P of the bridge have each been fitted with several grooves 2 having the general shape of a “C” as illustrated in FIGS. 4 to 7, and extending along one or several generatrices of the pylon. Bridge deck T likewise is fitted with one or several grooves 2 having the general shape of a “C”.

These generally C-shaped grooves 2 stabilize and control the water or air streams flowing around pylons P and deck T of the bridge, and have the effect that at a given velocity of water and/or air flow around these elements, they are subjected to lower constraints and forces.

In all these applications, the drag reduction device produces an important reduction of frictional drag and of total drag that results from the inversion of the direction of rotation of the eddies developing around the body immersed into the fluid, an effect that reduces the relative velocities of movement of the object and the fluid stream.

For a demonstration of feasibility and efficiency of the device according to the invention, first tests were made with a body immersed in water, this body having the shape of a nose cone 21 meters long with a maximum diameter of 2.8 meters (FIG. 12). In this figure, the size of the device according to the invention has been exaggerated relative to the nose cone dimensions in order to serve the needs of illustration.

In a first configuration (FIG. 13), such a nose cone has been fitted with a type of drag reduction device according to FIG. 8, that is, a device 2 incorporated into an element 6 fastened to the outside wall of the nose cone. This device has been placed at a distance of about 2.6 meters from the point of the nose cone) or of about 4.4 meters from the nose cone's maximum cross section. FIG. 13 illustrates the nose cone fitted with this device, partly in cross section. The diameter of groove 2 is of the order of 2.5 cm in this case.

For turbulent water flow, one notices according to the Spalart-Allmaras model (spl) that the device when present produces a slight increase in fluid pressure on the nose cone surface and an important decrease in frictional drag relative to an identical flow around the same nose cone lacking the device according to the invention. The numbers obtained are:

| | with device | without device | difference |
|---|---|---|---|
| pressure drag coefficient | 0.0080 | 0.0026 | |
| frictional drag coefficient | 0.0371 | 0.0445 | |
| total drag coefficient | 0.0451 | 0.0471 | −4.39% |

The same measurements have been made with a similar nose cone where the device according to the invention has been inlaid into the surface, that is, machined or obtained by forming (FIG. 14).

In this example the device has been placed into the same location of the nose cone as in the preceding example, except that the diameter of groove 2 has been raised to 5 cm, and the groove had a shape of the type illustrated in FIG. 7. The data obtained are:

| | with device | without device | difference |
|---|---|---|---|
| pressure drag coefficient | 0.0063 | 0.0026 | |
| frictional drag coefficient | 0.0378 | 0.0445 | |
| total drag coefficient | 0.0441 | 0.0471 | −6.49% |

In both cases an important decrease in total drag by about 4.4% to 6.5% has been obtained with a single device placed on top of or integrated into the surface of the nose cone.

For a further increase in this drag reduction, one may place several devices one behind the other onto the nose cone surface. Actually any given device produces an effect, only over a certain distance downstream from it, so that the phenomenon of inversion of the direction of rotation of the flow eddies can be repeated several times along the surface of the immersed body.

One may thus assume that the reduction of total drag acting on a body immersed into a fluid flow will be larger when using several drag reduction devices disposed one behind the other along the immersed body.

It is understood that the dimensions of groove 2, its shape, and its position relative to the body immersed into a fluid may modify its drag reduction efficiency.

One also notices a reduction of cavitation phenomena when using a drag reduction device according to the invention.

The drag reduction device according to the invention may equally well be used for a reduction of head loss and of cavitation in the flow of a fluid in pipes. This may prove to be important in many areas such as pressure pipes, fluid distribution networks, engine intake or exhaust manifolds, pipelines, etc.

FIG. 15 schematically illustrates in cross section the use of a drag reduction device inlaid or machined into the wall of piping.

FIG. 16 schematically illustrates in cross section the use of a drag reduction device attached to the inner wall of piping.

FIG. 17 illustrates a segment of an immersed body moving in water and having a drag reduction device that shows the water recirculation induced by this device.

In the case of piping as well, as soon as the fluid flow becomes turbulent, the groove 2 of the drag reduction device that is present inverts the direction of rotation of the fluid eddies, thus producing a reduction of the relative velocities of the piping and fluid layer in contact with the wall of this piping which in turn produces a reduction of the head loss and of the cavitation phenomena in the channel.

In the case of piping as well, grooves 2 can be arranged all along the pipes at distances corresponding to that over which the effect of the head loss reduction device is produced, so as to multiply the effect of reduction of the fluid's friction at the pipes and raise the yield of an installation.

In the case of piping, groove 2 is attached to or inlaid into the inner wall of the pipes, and is preferably closed upon itself, that is, continuous, since the fluid is in contact with the entire inner surface area of the pipes.

More thorough tests that have not yet been finished show that a groove 2 that is present in the surface of a body 1, extends perpendicularly to the fluid flow around body 1, and stretches over an angle of more than 180° gives rise to a double recirculation of fluid around body 1 in the region concerned. One sees a first recirculation I downstream from groove 2. The upper layer of this first recirculation that is at a distance from body 1 flows in the direction of the general fluid flow around the body, while the lower layer of this first recirculation I that is in contact with body 1 occurs in a direction opposite to that of the general fluid flow, so that the friction between body 1 and the fluid in this recirculation zone is reduced. One also sees a second recirculation II in groove 2 that forms a flow closed upon itself inside the groove.

In the region where groove 2 has its opening, the two recirculations are in contact and hence must have the same direction of rotation, which imposes the direction of rotation of the second recirculation II, that which occurs in groove 2 and which thus is contrary to the direction of rotation of the second circulation.

For a reduction of the turbulence in the zone where these two recirculations meet, one creates a ridge A at the downstream edge of groove 2. Working on the shape of this ridge A so as to decrease the zone of turbulence between recirculations I and II to the largest possible extent, one can limit the lost energy and lower the hydrodynamic resistance to the penetration of body 1 into the fluid.

In a general fashion, the device—that is, groove 2 and possibly ridge A—influences the boundary layer of the fluid flowing around body 1. Under these conditions the dimensions of these elements 2 and A are always slight or even very slight as compared to those of body 1, for instance a few centimeters while those of body 1 are of the order of 20 to 200 meters.

1. Device reducing the drag due to the relative movements of a body and a fluid, characterized in that within or on the surface of the body that is in contact with the fluid, and following a continuous line located essentially in a plane perpendicular to the fluid flow, it comprises means producing eddies the direction of rotation of which is controlled along at least part of the surface of the body, thus reducing the frictional forces between the fluid and the body, and hence the drag to which the body is subjected, or the head loss to which the fluid is subjected.

2. Device according to claim 1, characterized in that the means are arranged downstream from the body regions where turbulence normally develops.

3. Device according to claim 1, characterized in that the means consist of at least one groove produced in the body surface that is in contact with the fluid.

4. Device according to claim 1, characterized in that the means consist of at least one bulge attached to the body surface and in contact with the fluid, this bulge having at least one groove.

5. Device according to claim 1, characterized in that the means are arranged over the entire perimeter of the body surface in contact with the fluid.

6. Device according to claim 3, characterized in that the groove in cross section has the general shape of a U or C.

7. Device according to claim 6, characterized in that the free edges of the groove that face each other are situated in the extension of the body surface in contact with the fluid.

8. Device according to claim 6, characterized in that the free edges of the groove that face each other are offset relative to one another, at least one of these free edges being offset relative to the body surface in contact with the fluid.

9. Device according to claim 1, characterized in that it consists of a profile the underside of which is intended to be glued to a body, this profile having tapering edges and a thick central segment provided with a groove.

10. Device according to claim 9, characterized in that the groove produced in the profile has free edges that face each other and are situated in the extension of the body surface in contact with the fluid.

11. Device according to claim 1, characterized in that the means produce control of the fluid eddies along at least one part of the body surface in contact with the fluid.

12. Device according to claim 11, characterized in that the means produce the inversion of the direction of rotation of the fluid eddies along at least part of the body surface in contact with the fluid.

13. Device according to claim 1, characterized in that it is attached to or incorporated into the outer surface of a body totally or partly immersed into a fluid.

14. Device according to claim 13, characterized in that it is incorporated into a vehicle, train, ship, car, plane or a fixed structure, building, bridge, wind turbine, tower, or off-shore platform.

15. Device according to claim 1, characterized in that it is attached to or incorporated into the inner surface of a channel in which a fluid circulates.

16. Device according to claim 15, characterized in that it is incorporated into a pressure pipe, an engine intake or exhaust manifold, or a fluid distribution pipe.

17. Terrestrial, nautical, or aeronautical vehicle fitted with a device according to claim 1.

18. Channel or piping fined with a device according to claim 1.

19. Fixed structure or work fitted with a device according to claim 1.

20. Device according to claim 13, characterized in that the cross section of groove (2) stretches over an angle of more than 180°; that it extends over the entire surface of body (1) that is in contact with the fluid, essentially perpendicularly to the fluid flow.

21. Device according to claim 17, characterized in that directly downstream of groove (2) a ridge (A) emerges from the surface of body (1) and extends parallel to groove (2).

22. Device according to claim 17, characterized in that its presence gives rise to a second recirculation (II) of the fluid inside of groove (2) and to a first recirculation (I) downstream of groove (2), the direction of rotation of the second recirculation being such that its upper layer that is at a distance from the body flows in the direction of general fluid flow while its lower layer in contact with body (1) flows in the opposite direction, and that the direction of the second recirculation (II) is imposed by that of the first recirculation (I), since in the region corresponding to the opening of groove (2), the two recirculations (I, II) are in mutual contact.
